(19) United States
(12) Patent Application Publication
(10) Pub. No.: US 2015/0338619 A1
(43) Pub. Date: Nov. 26, 2015

(54) OPTICAL SYSTEM AND OPTICAL LENS

(71) Applicant: Union Optech Co., Ltd., Zhongshan (CN)

(72) Inventor: Junqiang GONG, Zhongshan (CN)

(21) Appl. No.: 14/622,795

(22) Filed: Feb. 13, 2015

(30) Foreign Application Priority Data
May 22, 2014 (CN) 201410219048.1

(51) Int. Cl. G02B 15/06; G02B 7/10; G02B 7/14; G02B 5/20

(52) U.S. Cl. CPC G02B 15/06; G02B 5/20; G02B 7/10; G02B 7/14

(57) ABSTRACT

An optical system, including a focusing lens group; a replaceable lens group; an optical filter; and an imaging surface. The replaceable lens group includes at least one lens and is disposed at one side of the focusing lens group facing an object space, and the at least one lens is replaceable so as to achieve the alteration of focal distance. The optical filter is disposed at one side of the focusing lens group facing the image group. The imaging surface is disposed at one side of the optical filter facing the image space.

### CROSS-REFERENCE TO RELATED APPLICATIONS

Pursuant to 35 U.S.C. §119 and the Paris Convention Treaty, this application claims the benefit of Chinese Patent Application No. 201410219048.1 filed May 22, 2014, the contents of which are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, Mass. 02142.

### BACKGROUND OF THE INVENTION

1. Field of the Invention

The invention relates to an optical system and an optical lens.

2. Description of the Related Art

Production processes for making conventional zoom lenses are complex and costly, and the yield of qualified products is low, all of which adversely affects the popularization of zoom lenses.

### SUMMARY OF THE INVENTION

In view of the above-described problems, it is one objective of the invention to provide an optical system and an optical lens that have simple production process and low production cost thereby being suitable for mass production. In addition, the optical system and an optical lens have functions of optical zooming and automatic focusing, and can photograph objects at a long or close distance.

To achieve the above objective, in accordance with one embodiment of the invention, there is provided an optical system comprising a focusing lens group; a replaceable lens group; an optical filter; and an imaging surface. The replaceable lens group comprises at least one lens and is disposed at one side of the focusing lens group facing an object space, and the at least one lens is replaceable whereby achieving the alteration of focal distance. The optical filter is disposed at one side of the focusing lens group facing an image group. The imaging surface is disposed at one side of the optical filter facing the image space.

In a class of this embodiment, the replaceable lens group is a long-range lens group, a macro lens group, or a wide-angle lens group.

In another aspect, the invention further provides an optical lens, comprising a focusing lens group; a replaceable lens group; an optical filter; an imaging surface; a focusing lens barrel; a fixed barrel frame; a replaceable lens barrel; and a driven element. The focusing lens group is disposed in the focusing lens barrel. The optical filter is disposed at one side of the focusing lens group facing an image group. The imaging surface is disposed at one side of the optical filter facing the image space. The fixed barrel frame is sleeved on the focusing lens barrel; one end of the fixed barrel frame facing an object space is provided with the replaceable lens barrel in a removable type. The replaceable lens group is disposed in the replaceable lens barrel. The driven element is disposed between the fixed barrel frame and the focusing lens barrel. When driven, the driven element drags the focusing lens barrel to move close to or away from the replaceable lens group.

In a class of this embodiment, the driven element comprises a driven sleeve fixed on the focusing lens barrel, and a guide rail is disposed between the driven sleeve and the fixed barrel frame; and when driven, the driven sleeve slides on the guide rail.

In a class of this embodiment, the replaceable lens group is a long-range lens group, a macro lens group, or a wide-angle lens group.

Advantages according to embodiments of the invention are summarized as follows:

1. The optical system and optical lens comprise the replaceable lens group so that the lens group is replaceable thereby achieving the long-rang, wide-angle and macro photography.

2. The optical system and optical lens are integrated and thus they are thin, which is beneficial to manufacturing thin smartphones, tablet PCs, and card digital camera.

3. The focusing lens barrel of the optical system is adjustable, so that the focusing lens group can be close to or away from the replaceable lens group to achieve the automatic focusing.

4. The replaceable lens group is a long-range lens group, a macro lens group, or a wide-angle lens group, so that a fixed focus optical structure can realize the function of a zoom optical imaging system, thereby reducing the technical costs and simplifying the product structure.

### DESCRIPTION OF THE DRAWINGS

The invention is described hereinbelow with reference to the accompanying drawings, in which:

FIG. 1 is a structure diagram of an optical imaging system in accordance with Example 1; and

FIG. 2 is a structure diagram of an optical imaging system in accordance with Example 2.

### DETAILED DESCRIPTION OF THE EMBODIMENTS

For further illustrating the invention, experiments detailing an optical system and an optical lens are described below. It should be noted that the following examples are intended to describe and not to limit the invention.

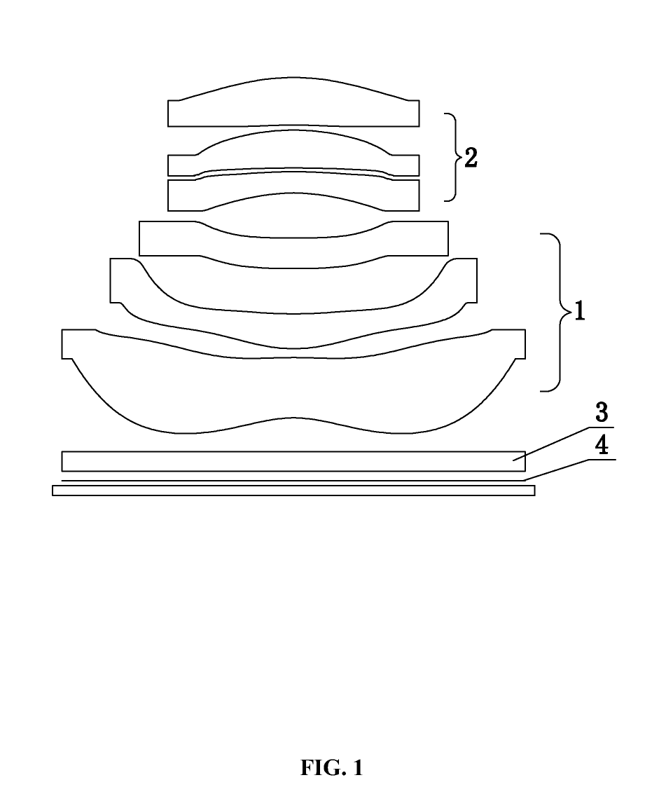

As shown in FIG. 1, an optical system comprises a focusing lens group 1; a replaceable lens group 2; an optical filter 3; and an imaging surface 4. The replaceable lens group 2 comprises at least one lens and is disposed at one side of the focusing lens group 1 facing an object space, and the at least one lens is replaceable whereby achieving the alteration of focal distance. The optical filter 3 is disposed at one side of the focusing lens group facing an image group. The imaging surface 4 is disposed at one side of the optical filter facing the image space. The replaceable lens group is a long-range lens group, a macro lens group, or a wide-angle lens group, which can achieve the long-range shot, micro-range shot, or wide-angle shot, respectively. When the replaceable lens group 2 is substituted, a voice coil actuator (also named automatic focusing mechanism or voice coil motor) is employed to automatically adjust the axial distance between the focusing lens group 1 and the replaceable lens group 2 whereby achieving the automatic focusing.

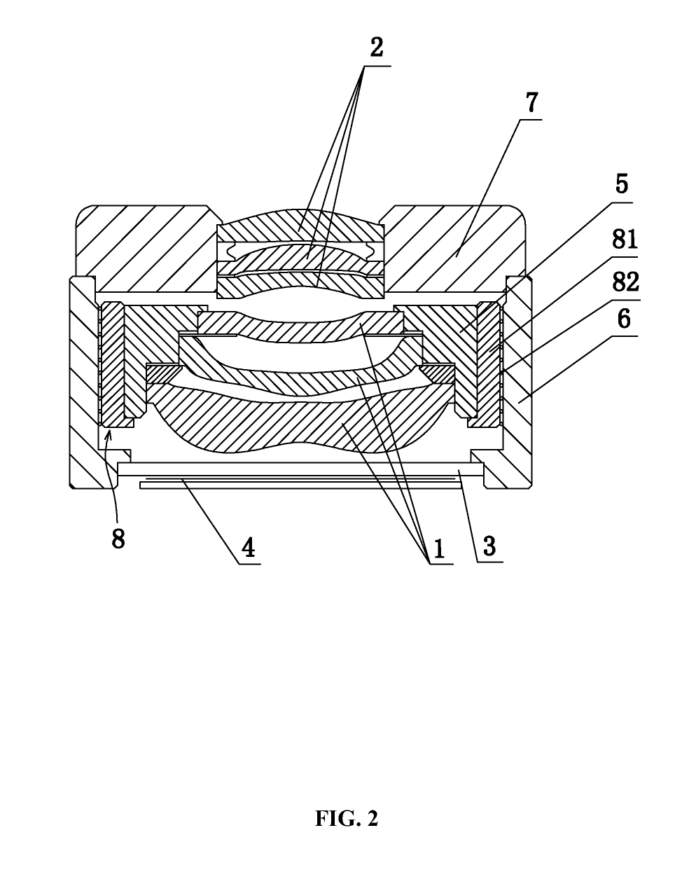

As shown in FIG. 2, an optical lens comprises a focusing lens group 1; a replaceable lens group 2; an optical filter 3; an imaging surface 4; a focusing lens barrel 5; a fixed barrel frame 6; a replaceable lens barrel 7; and a driven element 8. The focusing lens group 1 is disposed in the focusing lens barrel 5. The optical filter 3 is disposed at one side of the focusing lens group 1 facing an image group. The imaging surface 4 is disposed at one side of the optical filter 3 facing the image space. The fixed barrel frame 6 is sleeved on the focusing lens barrel 5; one end of the fixed barrel frame 6 facing an object space is provided with the replaceable lens barrel 7 in a removable type. The replaceable lens group 2 is disposed in the replaceable lens barrel 7. The driven element 8 is disposed between the fixed barrel frame 6 and the focusing lens barrel 5. When driven, the driven element 8 drags the focusing lens barrel 5 to move close to or away from the replaceable lens group 2. The driven element 8 comprises a driven sleeve 81 fixed on the focusing lens barrel 5, and a guide rail 82 is disposed between the driven sleeve 81 and the fixed barrel frame 6; and when driven, the driven sleeve 81 slides on the guide rail 82. The guide rail 82 is a linear guide. A voice coil actuator is employed to drive the driven sleeve 81. The driven sleeve 81 drags the focusing lens barrel 5 to slide on the linear guide whereby achieving automatic focusing. When the replaceable lens group 2 and the replaceable lens barrel 7 are substituted, under the action of electromagnetic induction, the voice coil motor (VCM) is employed to automatically adjust the axial distance between the focusing lens group 1 and the replaceable lens group 2 whereby achieving the automatic focusing.

When photographing an object in short distance, the replaceable lens group 2 employs a macro lens group. The replaceable lens barrel 7 is fixed on the front end of the fixed barrel frame 6. When shooting, the driven sleeve 81 is driven by a voice coil motor to move and drag the focusing lens barrel 5 whereby achieving the automatic adjustment of the axial distance between the focusing lens group 1 and the replaceable lens barrel 7 whereby achieving the automatic focusing to obtain a clear image. In this example, the optical system can photograph an object within 20 cm.

When photographing a wide-angle object, the replaceable lens group 2 employs a wide-angle lens group. The old replaceable lens barrel is taken down, and a new replaceable lens barrel 7 equipped with the wide-angle lens group is fixed on the front end of the fixed barrel frame 6. When shooting, the driven sleeve 81 is driven by a voice coil motor to move and drags the focusing lens barrel 5 whereby achieving the automatic adjustment of the axial distance between the focusing lens group 1 and the replaceable lens barrel 7 whereby achieving the automatic focusing to obtain a clear image. In this example, the optical system can photograph an object having a field angle of more than 80°.

When photographing an object in a long distance, the replaceable lens group 2 employs a long-range lens group. The old replaceable lens barrel is taken down, and a new replaceable lens barrel 7 equipped with the long-range lens group is fixed on the front end of the fixed barrel frame 6. When shooting, the driven sleeve 81 is driven by a voice coil motor to move and drags the focusing lens barrel 5 whereby achieving the automatic adjustment of the axial distance between the focusing lens group 1 and the replaceable lens barrel 7 whereby achieving the automatic focusing to obtain a clear image. In this example, the optical system can photograph an object that is over 10 m away.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. An optical system, comprising:
a) a focusing lens group;
b) a replaceable lens group;
c) an optical filter; and
d) an imaging surface;
wherein
the replaceable lens group comprises at least one lens and is disposed at one side of the focusing lens group facing an object space, and the at least one lens is replaceable whereby achieving the alteration of focal distance;
the optical filter is disposed at one side of the focusing lens group facing an image group; and
the imaging surface is disposed at one side of the optical filter facing the image space.

2. The system of claim 1, wherein the replaceable lens group is a long-range lens group, a macro lens group, or a wide-angle lens group.

3. An optical lens, comprising:
a) a focusing lens group;
b) a replaceable lens group;
c) an optical filter;
d) an imaging surface;
e) a focusing lens barrel;
f) a fixed barrel frame;
g) a replaceable lens barrel; and
h) a driven element;
wherein
the focusing lens group is disposed in the focusing lens barrel;
the optical filter is disposed at one side of the focusing lens group facing an image group;
the imaging surface is disposed at one side of the optical filter facing the image space;
the fixed barrel frame is sleeved on the focusing lens barrel;
one end of the fixed barrel frame facing an object space is provided with the replaceable lens barrel in a removable type;
the replaceable lens group is disposed in the replaceable lens barrel;
the driven element is disposed between the fixed barrel frame and the focusing lens barrel; and
when driven, the driven element drags the focusing lens barrel to move close to or away from the replaceable lens group.

4. The optical lens of claim 3, wherein the driven element comprises a driven sleeve fixed on the focusing lens barrel, and a guide rail is disposed between the driven sleeve and the fixed barrel frame; and when driven, the driven sleeve slides on the guide rail.

5. The optical lens of claim 3, wherein the replaceable lens group is a long-range lens group, a macro lens group, or a wide-angle lens group.
